(19) United States
(12) Patent Application Publication
(10) Pub. No.: US 2010/0026209 A1
(43) Pub. Date: Feb. 4, 2010

(54) LED driving circuit and method

(76) Inventor: Kuo-Chi Liu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,326

(22) Filed: Sep. 16, 2008

(30) Foreign Application Priority Data
Jul. 31, 2008 (TW) 097129109

(51) Int. Cl. H05B 41/36

(52) U.S. Cl. 315/297; 315/307

(57) ABSTRACT

A LED driving circuit includes a regulator to provide an output voltage to a LED light source, a current source to control the driving current of the LED light source, and a controller to detect the voltage of the current source to generate a control signal for the regulator to regulate the output voltage at a low level. There are no resistors on the current path established by the LED light source and current source, and the regulator may maintain the voltage of the current source as low as possible, thereby improving the power efficiency and reducing the power consumption.

### FIELD OF THE INVENTION

The present invention is related generally to a light-emitting diode (LED) driving circuit and method and, more particularly, to efficiency improvement of a LED driving circuit.

### BACKGROUND OF THE INVENTION

Recently, LEDs are extensively used as light sources in various applications. Since the brightness of LED is proportional to the driving current thereof, the LED driving circuit is required to well control the driving current. However, high power consumption and high temperature disadvantageously affect the LED's lifetime, efficiency and applications. FIG. 1 shows a conventional LED driving circuit 10, which includes a voltage source Vboost coupled to a LED string 12 and a transistor T11 coupled between the LED string 12 and a resistor Rref1 for controlling the driving current I1 of the LED string 12. The driving current I1 flows through the resistor Rref1 and thus produces a voltage Vsen1 thereacross, and the magnitude of the driving current I1 can be detected by detecting the voltage Vsen1. It is well known both the transistor T11 and the resistor Rref1 consume much power and thereby impair the performance of the LED driving circuit 10. In order to reduce the power consumption by the resistor Rref1, the resistor Rref1 must have very small resistance. However, it is extremely difficult to precisely control the resistance of a small resistor with existing technology.

FIG. 2 shows another conventional LED driving circuit 20, in which a LED string 22 is coupled between a voltage source Vboost and a current sensor 24. The current sensor 24 generates a current I3 proportional to the driving current I2 of the LED string 22, and the current I3 flows through a resistor Rref2 to generate a voltage Vsen2. The LED driving circuit 20 regulates the voltage Vboost by monitoring the voltage Vsen2, in order to control the driving current I2. In the LED driving circuit 20, the current sensor 24 is used to provide the smaller current 13 to the resistor Rref2, thereby lowering the power consumption by the resistor Rref2 and enhancing the efficiency of the LED driving circuit 20.

FIG. 3 shows yet another conventional LED driving circuit 30, which includes a regulator 32 for providing a constant voltage Vs to a red LED 34, a green LED 36 and a blue LED 38. A resistor R1 is coupled between the red LED 34 and a current source CS1; a resistor R2 is coupled between the green LED 36 and a current source CS2; and a resistor R3 is coupled between the blue LED 38 and a current source CS3. The current sources CS1, CS2 and CS3 are used to control the driving currents of the red, green and blue LEDs 34, 36 and 38, respectively, and the resistors R1, R2 and R3 share the power consumption of the current sources CS1, CS2 and CS3, respectively, to reduce thermal issues. The LED driving circuit 30 is advantageous to very precisely control the driving currents of the red, green and blue LEDs 34, 36 and 38. Nevertheless, power consumption by the LEDs 34, 36 and 38 and the resistors R1, R2 and R3 are increased as a result.

FIG. 4 shows test data of the system of FIG. 3, in which column R represents the resistances of the resistors R1, R2 and R3, column Vr represents the voltages of the resistors R1, R2 and R3, column Vcs represents the voltages of the current sources CS1, CS2 and CS3, column Vf represents the voltages of the LEDs 34,36 and 38, and column lled represents the driving currents of the LEDs 34, 36 and 38. Referring to FIGS. 3 and 4, and taking the red LED 34 for example, the regulator 32 provides a voltage Vs of 5V and the voltage of the red LED 34 is 2.1V. As the current source CS1 provides a current of 18 mA, the voltage of the resistor R1 of 50 ohm is 0.9V, and the voltage of the current source CS1 is 2V. Therefore, the power efficiency of the red LED 34 is only 42%. Also from the table of FIG. 4, the power efficiencies of the other two LEDs 36 and 38 are only 84% and 64%, respectively.

Therefore, it is desired a LED driving circuit improved in power efficiency.

### SUMMARY OF THE INVENTION

An object of the present invention is to provide a LED driving circuit such that the LED supply voltage is well controlled to operate at optimal voltage level.

Another object of the present invention is to provide a LED driving circuit with significantly improved power efficiency.

Still another object of the present invention is to provide a LED driving circuit for greatly reducing power consumption to improve thermal issue.

Yet another object of the present invention is to provide a LED driving circuit for precisely controlling the driving current.

In a LED driving circuit according to the present invention, a regulator provides an output voltage to a LED light source on a current path, a current source coupled to the LED light source precisely controls the driving current on the current path, and a controller coupled to the current source and regulator detects the voltage of the current source to generate a control signal for the regulator to regulate the output voltage. The regulator regulates the output voltage to maintain the voltage of the current source at a low level, and consequently, the output voltage is almost completely applied to the LED light source. Thus, not only is the power efficiency greatly increased and the power consumption significantly reduced, but also the thermal issue is improved. Moreover, as the power consumption decreases, the required total input power is reduced, and thereby the power capacity of the regulator is allowed to be reduced.

When driving multiple LED light sources, the regulator may provide a single output voltage for all the LED light sources or multiple output voltages each for one of the LED light sources.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a conventional LED driving circuit;

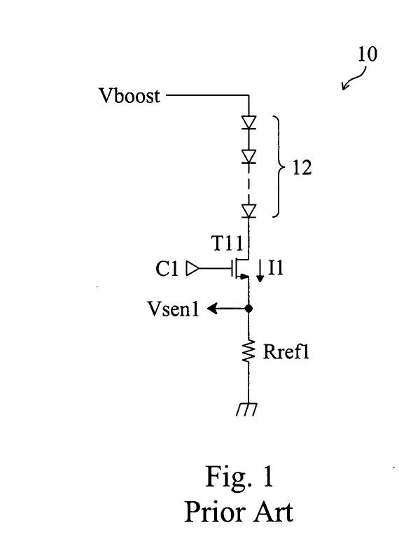

FIG. 2 is a circuit diagram of another conventional LED driving circuit;

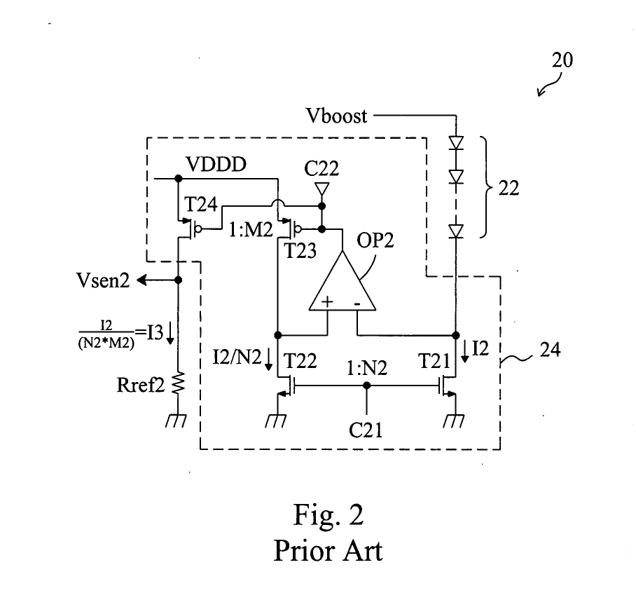

FIG. 3 is a circuit diagram of yet another conventional LED driving circuit;

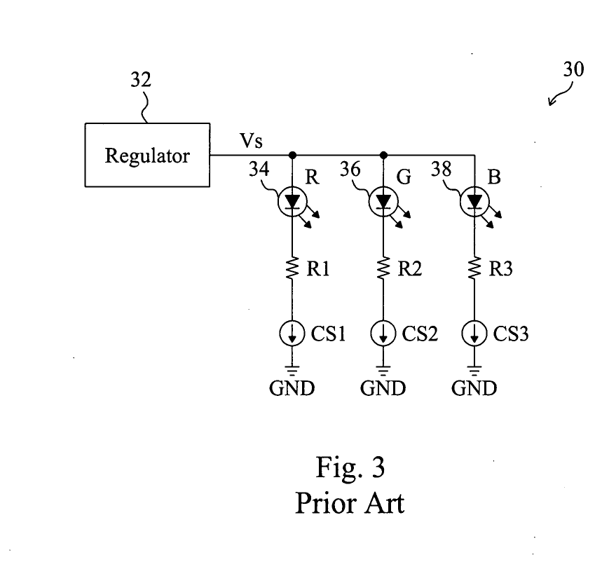

FIG. 4 is a table of test data of the system of FIG. 3;

FIG. 5 is a circuit diagram of a first embodiment according to the present invention;

FIG. 6 is a circuit diagram of a second embodiment according to the present invention;

FIG. 7 is a circuit diagram of an embodiment for the controller shown in FIG. 6;

FIG. 8 is a circuit diagram of a third embodiment according to the present invention; and

FIG. 9 is a table of test data of the system of FIG. 8.

### DETAILED DESCRIPTION OF THE INVENTION

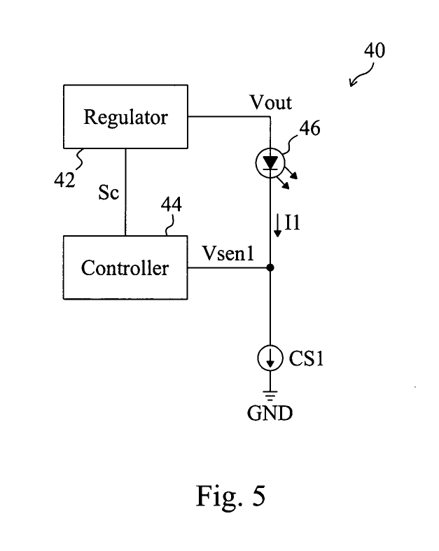

FIG. 5 shows a first embodiment according to the present invention. In a LED driving circuit 40, a regulator 42 provides an output voltage Vout to a LED light source 46 which may include an LED or a LED string, a current source CS1 is coupled to the LED light source 46 to control the driving current I1 of the LED light source 46, and a controller 44 detects the voltage Vsen1 of the current source CS1 to generate a control signal Sc, for the regulator 42 to regulate the output voltage Vout to maintain the voltage Vsen1 of the current source CS1 at a low level. The regulator 42 may be a switching buck converter, a switching boost converter or a switching buck-boost converter. The voltage Vsen1 of the current source CS1 is controlled as low as possible, for example at 0.2V, only if the current source CS1 could operate normally. Based on the detected voltage Vsen1, the controller 44 controls the regulator 42 to regulate the output voltage Vout and thereby maintain the output voltage Vout at an appropriate level. For instance, if the LED light source 46 needs an operating voltage of 3.2V, the output voltage Vout will be controlled at 3.4V, and the power efficiency is approximately 94%. Since there are no resistors serially connected to the current path established by the current source CS1 and the LED light source 46, the supplied voltage Vout is almost all applied to the LED light source 46, and thus the power consumption is significantly reduced and thermal issue is improved. On the other hand, as the power consumption decreases, the required total input power is reduced, so that the power capacity of the regulator 42 can be reduced.

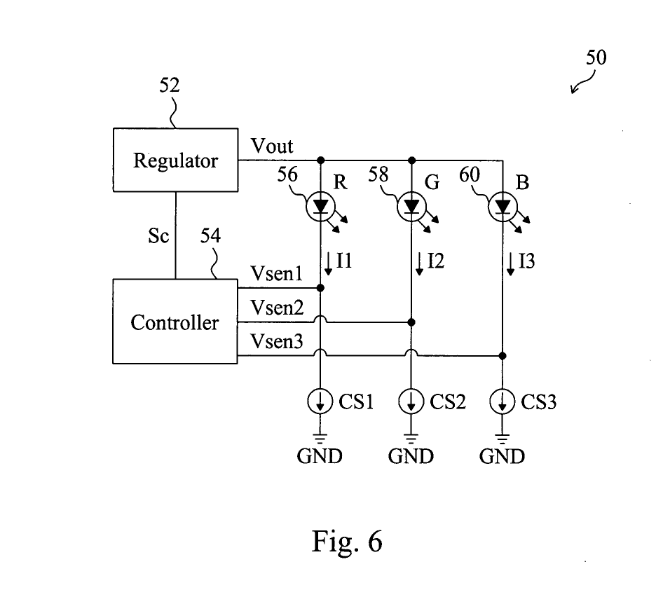

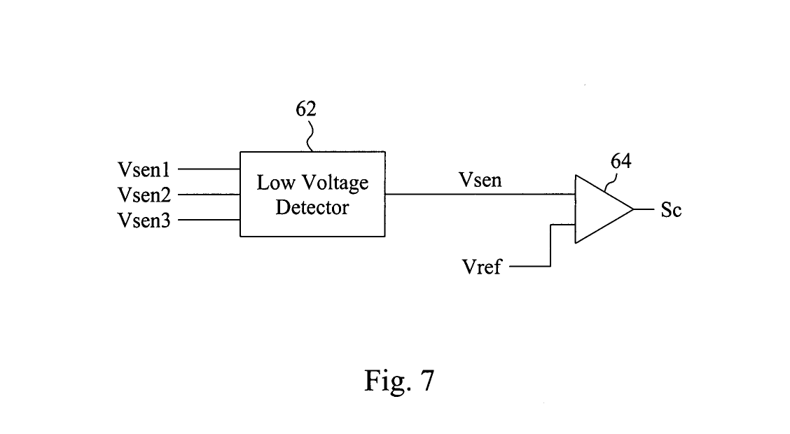

FIG. 6 shows a LED driving circuit 50 according to the present invention, in which a regulator 52 provides an output voltage Vout to a red LED light source 56, a green LED light source 58 and a blue LED light source 60, current sources CS1, CS2 and CS3 are coupled to the LED light sources 56-60 to control the driving currents I1, I2 and I3 thereof, respectively, and a controller 54 detects the voltages Vsen1, Vsen2 and Vsen3 of the current sources CS1, CS2 and CS3, respectively, to generate a control signal Sc for the regulator 52 to regulate the output voltage Vout, to maintain the voltages Vsen1, Vsen2 and Vsen3 each at a low level. The regulator 52 may be a switching buck converter, a switching boost converter or a switching buck-boost converter. FIG. 7 shows an embodiment for the controller 54 of FIG. 6, which includes a low voltage detector 62 for detecting the lowest one of the voltages Vsen1, Vsen2 and Vsen3 to generate a signal Vsen accordingly, and a differential amplifier 64 to compare the signal Vsen with a reference signal Vref to generate the control signal Sc. In the LED driving circuit 50, the voltages Vsen1, Vsen2 and Vsen3 of the current sources CS1, CS2 and CS3 are controlled as low as possible, only if the current sources CS1, CS2 and CS3 could operate normally. Based on the detected lowest voltage, the controller 54 controls the regulator 52 to regulate the output voltage Vout to maintain the output voltage Vout at an appropriate level and improve the power efficiency. Since there are no resistors in any one of the current paths I1-I3 established by the LED light sources and the current sources 56, CS1, 58, CS2 and 60, CS3, almost all of the supplied voltage Vout is applied to the LED light sources 56-60. Thus, the power consumption is significantly reduced and the thermal issue is improved. On the other hand, as the power consumption decreases, the required total input power is reduced, so that the power capacity of the regulator 52 can be reduced.

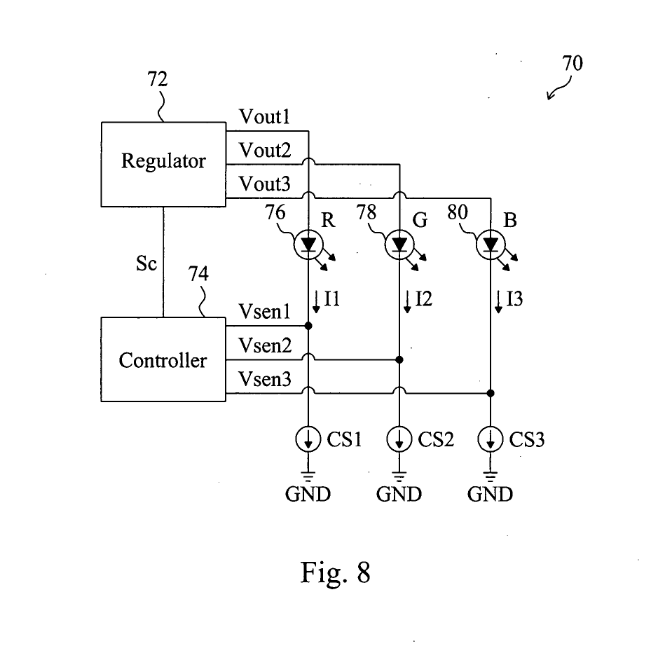

In the third embodiment shown FIG. 8, a LED driving circuit 70 includes a regulator 72 to provide output voltage Vout1, Vout2 and Vout3 to a red LED light source 76, a green LED light source 78 and a blue LED light source 80, respectively, current sources CS1, CS2 and CS3 are coupled to the LED light sources 76-80 to control the driving current I1, I2 and I3, respectively, and a controller 74 to detect the voltages Vsen1, Vsen2 and Vsen3 of the current sources CS1, CS2 and CS3 to generate a control signal Sc for the regulator 72 to regulate the output voltages Vout1, Vout2 and Vout3 to maintain the voltages Vsen1, Vsen2 and Vsen3 of the current sources CS1, CS2 and CS3 as low as possible, only if the current sources CS1, CS2 and CS3 could operate normally. In this embodiment, the output voltages Vout1, Vout2 and Vout3 are regulated according to the voltages Vsen1, Vsen2 and Vsen3, respectively. The regulator 72 may be a switching buck converter, a switching boost converter or a switching buck-boost converter.

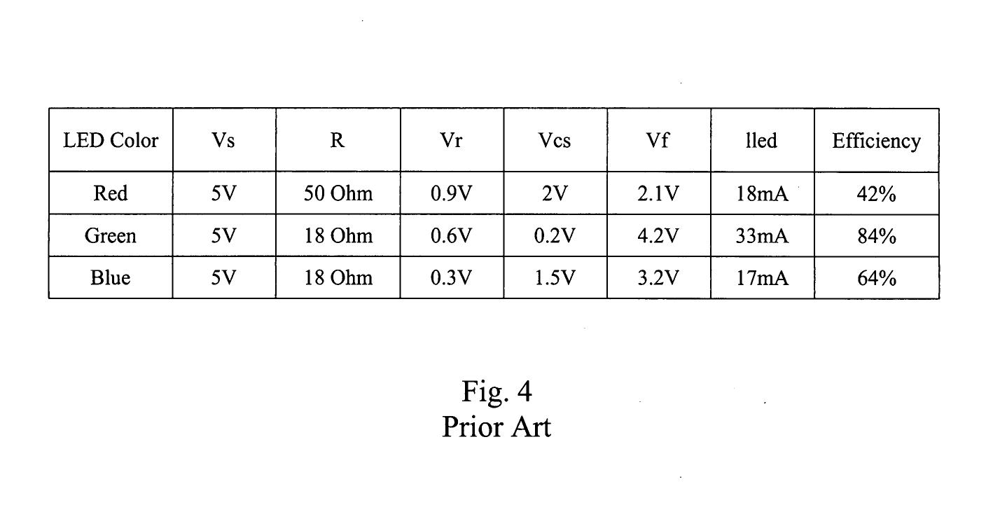

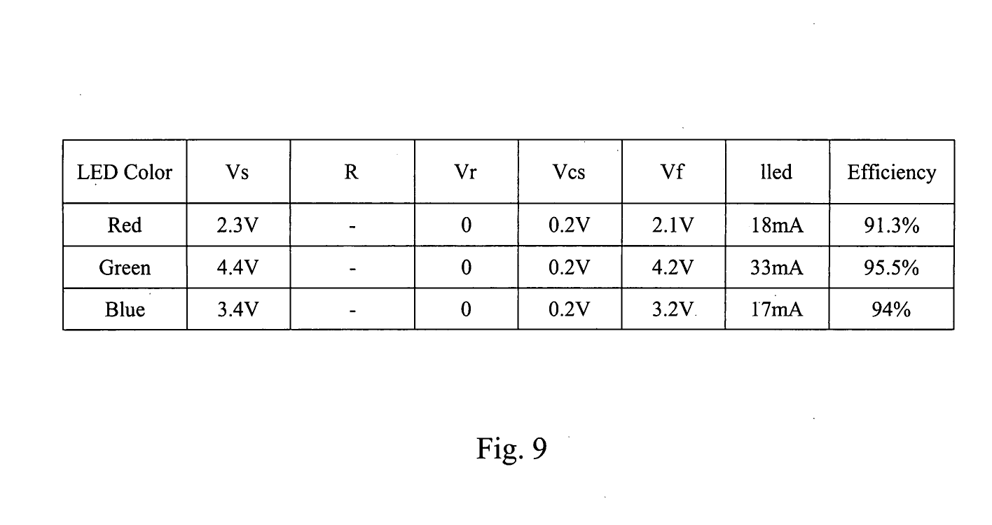

FIG. 9 shows test data of the system of FIG. 8, in which column Vs represents the output voltages Vout1, Vout2 and Vout3 provided by the regulator 72, column Vcs represents the voltages of the current sources CS1, CS2 and CS3, column Vf represents the voltages of the LED light sources 76, 78 and 80, and column lled represents the driving currents I1, I2 and I3 of the LED light sources 76, 78 and 80. Referring to FIGS. 8 and 9, the voltage of the red LED light source 76 is 2.1V and the voltage of the current source CS1 is 0.2V, so that the output voltage Vout1 is 2.3V. Hence, the power efficiency of the red LED light source 76 is approximately 91.3%. The voltage of the green LED light source 78 is 4.2V, and the voltage of the current source CS2 is 0.2V, and therefore the output voltage Vout2 is 4.4V. Consequently, the power efficiency of the green LED light source 78 is approximately 95.5%. The voltage of the blue LED light source 80 is 3.2V, and the voltage of the current source CS3 is 0.2V, and therefore the output voltage Vout3 is 3.4V. Hence, the power efficiency of the blue LED light source 80 is approximately 94%. The comparison between the tables of FIG. 9 and FIG. 4 clearly demonstrates that the LED driving circuit 70 of the present invention has much higher power efficiency. Besides, since there are no resistors on any one of the current paths I1-I3 established by the current sources CS1-CS3 and the LED light sources 76-80, each of the supplied voltages Vout1-Vout3 will be almost all applied to its respective one of the LED light sources 76-80. Thus, the power consumption can be greatly reduced and the thermal issue is improved. On the other hand, as the power consumption decrease, the required total input power is reduced, and therefore the power capacity of the regulator 72 can be reduced.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A LED driving circuit for driving a LED light source, comprising:
a regulator coupled to the LED light source to provide an output voltage thereto;
a current source coupled to the LED light source to control a driving current thereof; and
a controller coupled to the current source and regulator to detect a voltage of the current source to generate a control signal for the regulator to regulate the output voltage.

2. The LED driving circuit of claim 1, wherein the LED light source and current source establish a current path of the driving current without any resistor thereon.

3. A LED driving circuit for driving a plurality of LED light sources, comprising:
a regulator coupled to the plurality of LED light sources to provide an output voltage thereto;
a plurality of current sources, each coupled to one of the plurality of LED light sources to control a driving current thereof; and
a controller coupled to the plurality of current sources and the regulator to detect each voltage of those of the plurality of current sources to generate a control signal for the regulator to regulate the output voltage.

4. The LED driving circuit of claim 3, wherein the controller determines the control signal according to a lowest one of the detected voltages from the plurality of current sources.

5. The LED driving circuit of claim 3, wherein the controller comprises:
a low voltage detector coupled to the plurality of current sources to detect all the voltages of the plurality of current sources to select a lowest one therefrom; and
a differential amplifier coupled to the low voltage detector and the regulator to compare the lowest voltage selected by the low voltage detector with a reference voltage to generate the control signal.

6. The LED driving circuit in claim 3, wherein each of the plurality of LED light sources and its coupled current source establish a current path of the respective driving current without any resistor thereon.

7. A LED driving circuit for driving a plurality of LED light sources, comprising:
a regulator coupled to the plurality of LED light sources to provide a plurality of output voltages, each supplied to one of the plurality of LED light sources;
a plurality of current sources, each coupled to one of the plurality of LED light sources to control a driving current thereof; and
a controller coupled to the plurality of current sources and the regulator to detect each voltage of those of the plurality of current sources to generate a control signal for the regulator to regulate the plurality of output voltages;
wherein the regulator regulates the plurality of output voltages according to the voltages of the plurality of current sources, respectively.

8. The LED driving circuit of claim 7, wherein each of the plurality of LED light sources and its coupled current source establish a current path of the respective driving current without any resistor thereon.

9. A LED driving method for a LED light source, comprising the steps of:
providing an output voltage to the LED light source;
providing a driving current for the LED light source by a current source coupled to the LED light source; and
detecting a voltage of the current source to generate a control signal to regulate the output voltage.

10. The LED driving method of claim 9, wherein the LED light source and current source establish a current path of the driving current without any resistor thereon.

11. A LED driving method for a plurality of LED light sources, comprising the steps of:
providing an output voltage to the plurality of LED light sources;
providing a plurality of driving currents by a plurality of current sources coupled to the plurality of LED light sources, respectively; and
detecting voltages of the plurality of current sources to generate a control signal to regulate the output voltage.

12. The LED driving method of claim 11, wherein the step of detecting voltages of the plurality of current sources to generate a control signal to regulate the output voltage comprises determining the control signal according to a lowest one of the detected voltages from the plurality of current sources.

13. The LED driving method of claim 11, wherein the step of detecting voltages of the plurality of current sources to generate a control signal to regulate the output voltage comprises:
selecting a lowest one from the voltages of the plurality of current sources; and
comparing the lowest voltage with a reference voltage to generate the control signal.

14. The LED driving method of claim 11, wherein each of the plurality of LED light sources and its coupled current source establish a current path of the respective driving current without any resistor thereon.

15. A LED driving method for a plurality of LED light sources, comprising the steps of:
providing a plurality of output voltages for the plurality of LED light sources, respectively;
providing a plurality of driving currents by a plurality of current sources coupled to the plurality of LED light sources, respectively; and
detecting voltages of the plurality of current sources to generate a control signal to regulate the plurality of output voltages, respectively.

16. The LED driving method of claim 15, wherein each of the plurality of LED light sources and its coupled current source establish a current path of the respective driving current without any resistor thereon.
